(19) United States
(12) Patent Application Publication
(10) Pub. No.: US 2006/0167162 A1
(43) Pub. Date: Jul. 27, 2006

(54) Thermoplastic polyester molding compositions

(75) Inventor: Michael Geprags, Schwarzheide (DE)

Correspondence Address: CONNOLLY BOVE LODGE & HUTZ LLP, SUITE 800, 1990 M STREET NW, WASHINGTON, DC, 20036-3425, US

(73) Assignee: BASF AKTIENGESELLSCHAFT Patents, Trademarks and Licenses, Ludwigshafen (DE)

(21) Appl. No.: 10/526,379

(22) PCT Filed: Aug. 29, 2003
(86) PCT No.: PCT/EP03/09598

§ 371 Date: Mar. 3, 2005

(30) Foreign Application Priority Data
Sep. 4, 2002 (DE) 102 41 297.9

(51) Int. Cl. C08K 3/34

(52) U.S. Cl. 524/451

(57) ABSTRACT

The invention relates to thermoplastic molding compositions comprising A) from 10 to 89.9% by weight of a thermoplastic polyester with a viscosity number (VN) of at least 145 ml/g B) from 10 to 89.99% by weight of a thermoplastic polyester with a viscosity number (VN) of not more than 135 ml/g C) from 0.01 to 5% by weight of at least one nucleating agent D) from 0 to 5% by weight of at least one lubricant E) from 0 to 70% by weight of other additives, the total of the percentages by weight of components A) to E) being 100%.

The invention relates to thermoplastic molding compositions comprising
A) from 10 to 89.9% by weight of a thermoplastic polyester with a viscosity number (VN) of at least 145 ml/g
B) from 10 to 89.99% by weight of a thermoplastic polyester with a viscosity number (VN) of not more than 135 ml/g
C) from 0.01 to 5% by weight of at least one nucleating agent
D) from 0 to 5% by weight of at least one lubricant
E) from 0 to 70% by weight of other additives, the total of the percentages by weight of components A) to E) being 100%.

The invention further relates to a process for preparing thermoplastic polyester molding compositions, and to the use of the molding compositions of the invention for producing fibers, films, or moldings of any type, and also to the resultant moldings of the invention, in particular headlamp panels.

Mixtures of polyesters of different viscosity are known. However, stability problems often arise during processing, which is most affected by the addition of various stabilizers. Automotive headlamp applications require not only high heat resistance and dimensional stability but also a very low level of fogging together with the capability of the moldings to be metallized cost-effectively.

Fogging is the formation of a deposit on the headlamp lens, and can arise on heating of the headlamp reflector or headlamp panel, due to the evaporation of volatile solids present.

The headlamp panels used hitherto in the automotive sector are composed of bulk-molded compounds (BMC), of thermoplastics, such as polycarbonate, polyether sulfone, polyamide (nylon-6+nylon-6,6), or high-temperature polycarbonate.

Disadvantages of these panels are
in the case of BMC, the high rejection rate due to the difficulty of adapting thermosets to the process
lack of dimensional stability due to water absorption in the case of PA
requirement for pretreatment of the molded product prior to metallization in the case of HT-PC and PC
relatively high density in the case of polyether sulfone.

It is an object of the present invention, therefore, to provide polyester molding compositions which minimize the abovementioned disadvantages and are simple to prepare.

We have found that this object is achieved by means of the molding compositions defined at the outset. Preferred embodiments are given in the subclaims.

A preparation process has also been found. This further reduces fogging and comprises mixing components A) to C), and also, where appropriate, D) and/or E), compounding them in the presence of water, and devolatilizing, discharging, cooling, and pelletizing the product.

As component A), the molding compositions of the invention comprise from 10 to 89.9% by weight, preferably from 20 to 85% by weight, and in particular from 30 to 80% by weight, of a thermoplastic polyester with a viscosity number of at least 145 ml/g, preferably at least 150 ml/g, and in particular at least 155 ml/g.

Use is generally made of polyester A) based on aromatic dicarboxylic acids and on an aliphatic or aromatic dihydroxy compound.

A first group of preferred polyesters is that of polyalkylene terephthalate, in particular those having from 2 to 10 carbon atoms in the alcohol moiety.

Polyalkylene terephthalates of this type are known per se and are described in the literature. Their main chain contains an aromatic ring which derives from the aromatic dicarboxylic acid. There may also be substitution in the aromatic ring, e.g. by halogen, such as chlorine or bromine, or by C₁-C₄-alkyl, such as methyl, ethyl, iso- or n-propyl, or n-, iso-, or tert-butyl.

These polyalkylene terephthalates may be prepared by reacting aromatic dicarboxylic acids, or their esters or other ester-forming derivatives, with aliphatic dihydroxy compounds in a manner known per se.

Preferred dicarboxylic acids are 2,6-naphthalenedicarboxylic acid, terephthalic acid and isophthalic acid, and mixtures of these. Up to 30 mol %, preferably not more than 10 mol %, of the aromatic dicarboxylic acids may have been replaced by aliphatic or cycloaliphatic dicarboxylic acids, such as adipic acid, azelaic acid, sebacic acid, dodecanedioic acids, or cyclohexanedicarboxylic acids.

Preferred aliphatic dihydroxy compounds are diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol, and neopentyl glycol, and mixtures of these.

Particularly preferred polyesters A) are polyalkylene terephthalates derived from alkanediols having from 2 to 6 carbon atoms. Among these, particular preference is given to polyethylene terephthalate, polypropylene terephthalate, and polybutylene terephthalate, and mixtures of these. Preference is also given to PET and/or PBT which comprise up to 1% by weight, preferably up to 0.75% by weight, of 1,6-hexanediol and/or 2-methyl-1,5-pentanediol as other monomer units.

The viscosity number of the polyester A) is generally measured to ISO 1628 in a 0.5% strength by weight solution in a phenol/o-dichlorobenzene mixture (ratio 1:1 by weight) at 25° C.

Preference is given to polyesters whose carboxy end group content is greater than 15 mval/kg, in particular greater than 18 mval/kg. Polyesters of this type may be prepared, for example, by the process of DE-A 44 01 055. The carboxy end group content is usually determined by titration methods (e.g. potentiometry).

It is also advantageous to use recycled PET materials (also termed scrap PET), where appropriate in a mixture with polyalkylene terephthalates, such as PBT.

Recycled materials are generally:
1) those known as post industrial recycled materials: these are production wastes from polycondensation or from processing, e.g. sprues from injection molding, start-up material from injection molding or extrusion, or edge trims from extruded sheets or films.
2) Post-consumer recycled materials: these are plastic items which are collected and treated after utilization by the end consumer. Blow-molded PET bottles for mineral water, soft drinks, and juices are easily predominant items in terms of quantity.

Both types of recycled material may be used either as regrind or in the form of pellets. In the latter case, the crude recycled materials are isolated and purifed, and then melted and pelletized using an extruder. This usually facilitates handling and promotes free-flowing properties, and metering capability for further steps in processing.

The recycled materials used may be in the form either of pellets or of regrind. The edge length should not be more than 6 mm, and should preferably be less than 5 mm.

Because polyesters undergo hydrolytic cleavage during processing (due to traces of moisture) it is advisable to predry the recycled material. The residual moisture content after drying is preferably <0.2%, in particular <0.05%.

Another class to be mentioned is that of fully aromatic polyesters deriving from aromatic dicarboxylic acids and aromatic dihydroxy compounds.

Suitable aromatic dicarboxylic acids are the compounds previously described for the polyalkylene terephthalates. The mixtures preferably used comprise from 5 to 100 mol % of isophthalic acid and from 0 to 95 mol % of terephthalic acid, in particular from about 50 to about 80% of terephthalic acid and from about 20 to about 50% of isophthalic acid.

The aromatic dihydroxy compounds preferably have the formula 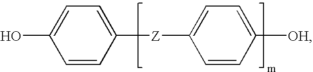
where Z is an alkylene or cycloalkylene group having up to 8 carbon atoms, arylene having up to 12 carbon atoms, carbonyl, sulfonyl, oxygen, or sulfur, or a chemical bond, and where m is from 0 to 2. The phenylene groups in the compounds may also have substitution by C₁-C₆-alkyl or alkoxy groups and fluorine, chlorine, or bromine.

Examples of parent compounds for these compounds are

dihydroxybiphenyl,

di(hydroxyphenyl)alkane,

di(hydroxyphenyl)cycloalkane,

di(hydroxyphenyl)sulfide,

di(hydroxyphenyl)ether,

di(hydroxyphenyl)ketone,

di(hydroxyphenyl)sulfoxide,

α,α′-di(hydroxyphenyl)dialkylbenzene,

di(hydroxyphenyl)sulfone, di(hydroxybenzoyl)benzene,

resorcinol, and

hydroquinone, and also the ring-alkylated or ring-halogenated derivatives of these.

Among these, preference is given to
4,4′-dihydroxybiphenyl,
2,4-di(4′-hydroxyphenyl)-2-methylbutane,
α,α′-di(4-hydroxyphenyl)-p-diisopropylbenzene,
2,2-di(3′-methyl-4′-hydroxyphenyl)propane, and
2,2-di(3′-chloro-4′-hydroxyphenyl)propane,
   and also in particular to
2,2-di(4′-hydroxyphenyl)propane,
2,2-di(3′,5-dichlorodihydroxyphenyl)propane,
1,1-di(4′-hydroxyphenyl)cyclohexane,
3,4′-dihydroxybenzophenone,
4,4′-dihydroxydiphenyl sulfone, and
2,2-di(3′,5′-dimethyl-4′-hydroxyphenyl)propane,
   and mixtures of these.

Of course, it is also possible to use mixtures of polyalkylene terephthalates and fully aromatic polyesters. These generally comprise from 20 to 98% by weight of the polyalkylene terephthalate and from 2 to 80% by weight of the fully aromatic polyester.

Of course, it is also possible to use polyester block copolymers, such as copolyetheresters. Products of this type are known per se and are described in the literature, e.g. in U.S. Pat. No. 3,651,014.

Corresponding products are also available commercially, e.g. Hytrel® (DuPont).

As component B), the molding compositions of the invention comprise from 10 to 89.9% by weight, preferably from 20 to 85% by weight, and in particular from 30 to 80% by weight, of a thermoplastic polyester with a viscosity number of not more than 135 ml/g, preferably not more than 133 ml/g, and in particular not more than 130 ml/g.

The structure and preparation of component B) correspond to the descriptions for component A), and for further details reference is therefore made to those descriptions.

The VN of the polyesters B) is generally determined to ISO 1628 in a 0.5% by weight solution in a phenol/o-dichlorobenzene mixture (ratio 1:1 by weight) at 25° C. The VN of component B) is at least 90 ml/g, preferably at least 100 ml/g, and in particular at least 107 ml/g.

Particularly preferred A):B) ratios are from 70:30 to 30:70, very particularly from 40:60 to 60:40.

The difference in the VNs of A) and B) is preferably 10 ml/g, in particular from 25 to 35 ml/g.

The carboxy group content of component B) is preferably up to 30 mval/kg, and in particular up to 28 mval/kg.

Particularly preferred mixtures are PET with PBT and PBT as components A) and B).

As component C), the molding compositions of the invention comprise from 0.01 to 5% by weight, preferably from 0.05 to 1% by weight, and in particular from 0.1 to 0.5% by weight, of a nucleating agent.

Nucleating agents which may be used are any of the known compounds, for example boron compounds, such as boron nitride, silica, pigments, e.g. Heliogen Blue® (copper phthalocyanine pigment; registered trade mark of BASF Aktiengesellschaft), carbon blacks, magnesium sulfate, mica, magnesium oxide, and the rutile and anatase forms of titanium dioxide.

Talc in particular is used as a nucleating agent, and is a hydrated magnesium silicate of the formula Mg₃[(OH)₂/Si₄O₁₀] or 3MgO.4SiO₂.H₂O. This is termed a three-layer phyllosilicate, and has a triclinic, monoclinic, or rhombic crystal structure and a lamellar appearance. Other trace elements which may be present are Mn, Ti, Cr, Ni, Na, and K, and some of the OH groups may have been replaced by fluoride.

Particular preference is given to the use of talc in which 100% of the particle sizes are <20 μm. The particle size distribution is usually determined by sedimentation analysis, and is preferably:

| | | |
|---|---|---|
| <20 | μm | 100% by weight |
| <10 | μm | 99% by weight |
| <5 | μm | 85% by weight |
| <3 | μm | 60% by weight |
| <2 | μm | 43% by weight |

Products of this type are commercially available as Micro-Talc I.T. extra (Norwegian Talc Minerals).

As component D), the molding compositions of the invention may comprise from 0 to 5% by weight, in particular from 0.01 to 5% by weight, preferably from 0.05 to 1% by weight, and in particular from 0.1 to 0.5% by weight, of at least one lubricant. Preferred lubricants are esters or amides of saturated or unsaturated aliphatic carboxylic acids having from 10 to 40, particularly from 16 to 22, carbon atoms, with saturated aliphatic alcohols or amines having from 2 to 40, preferably from 2 to 6, carbon atoms.

The carboxylic acids may be mono- or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to ethylene glycol, glycerol, and pentaerythritol.

The aliphatic amines may be mono- to trifunctional. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use mixtures of various esters or amides, or esters with amides, in combination, in any desired mixing ratio.

The molding compositions of the invention may comprise up to 70% by weight, preferably up to 40% by weight, and in particular up to 30% by weight, of other additives E).

Examples of other additives E) are amounts of up to 40% by weight, preferably up to 30% by weight, of elastomeric polymers (often also termed impact modifiers, elastomers, or rubbers).

Very generally copolymers preferably composed of at least two of the following monomers: ethylene, propylene, butadiene, isobutene, isoprene, chloroprene, vinyl acetate, styrene, acrylonitrile, and acrylic or methacrylic esters having from 1 to 18 carbon atoms in the alcohol component.

Examples of polymers of this type are described in Houben-Weyl, Methoden der organischen Chemie, vol. 14/1 (Georg-Thieme-Verlag, Stuttgart, 1961), pp. 392 to 406, and in the monograph by C. B. Bucknall, “Toughened Plastics” (Applied Science Publishers, London, 1977).

Some preferred types of these elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyl-tricyclo[5.2.1.0^{2,6}]-3,8-decadiene, or mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM rubbers or EPDM rubbers may also have been grafted with reactive carboxylic acids or derivatives of these. Examples which may be mentioned here are acrylic acid, methacrylic acid, and derivatives thereof, e.g. glycidyl(meth)acrylate, and also maleic anhydride.

Another group of preferred rubbers is that of copolymers of ethylene with acrylic acid and/or methacrylic acid and/or with the esters of these acids. In addition, the rubbers may also contain dicarboxylic acids, such as maleic acid and fumaric acid, or derivatives of these acids, e.g. esters and anhydrides, and/or contain monomers having epoxy groups. These dicarboxylic acid derivatives or monomers containing epoxy groups are preferably incorporated into the rubber by adding, to the monomer mixture, monomers of the formula I, or II, or III or IV, having dicarboxylic acid groups or having epoxy groups 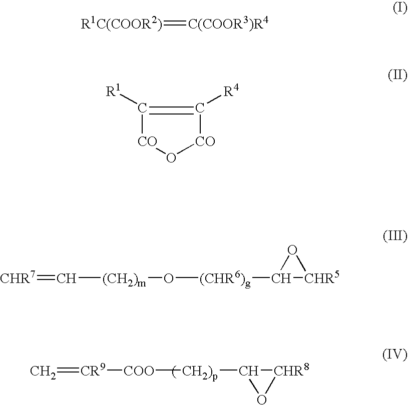
where R¹ to R⁹ are hydrogen or alkyl having from 1 to 6 carbon atoms, and m is an integer from 0 to 20, g is an integer from 0 to 10 and p is an integer from 0 to 5.

R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II, and IV are maleic acid, maleic anhydride, and esters of acrylic and/or methacrylic acid contain epoxy groups, examples being glycidyl acrylate, glycidyl methacrylate, and the esters with tertiary alcohols, e.g. tert-butyl acrylate. Although the latter have no free carboxy groups, their behavior approximates to that of the free acids, and they are therefore termed monomers having latent carboxy groups.

The copolymers are advantageous composed of from 50 to 98% by weight of ethylene, from 0.1 to 20% by weight of monomers containing epoxy groups, and/or monomers comprising methacrylic acid and/or containing anhydride groups, the remaining amount being (meth)acrylic esters.

Particular preference is given to copolymers made from
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particcular from 10 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well known.

Preferred elastomers also include emulsion polymers whose preparation is described, for example, by Blackley in the monograph “Emulsion Polymerization”. The emulsifiers and catalysts which may be used are known per se.

In principle it is possible to use homogeneously structured elastomers or those with a shell construction. The shell-type structure is determined, inter alia, by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, and corresponding methacrylates, and butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). When elastomers have more than one shell it is also possible for more than one shell to be composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the formula 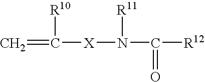
where:
R¹⁰ is hydrogen or C₁- to C₄-alkyl,
R¹¹ is hydrogen, C₁-C₈-alkyl group or an aryl group, in particular phenyl,
R¹² is hydrogen, C₁-C₁₀-alkyl, C₆-C₁₂-aryl or —OR¹³
R¹³ is C₁-C₈-alkyl or C₆-C₁₂-aryl, if desired with substitution by O- or N-containing groups,
X is a chemical bond, C₁-C₁₀-alkylene or C₆-C₁₂-arylene, or
Y is O-Z or NH-Z where 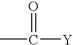
   Z is C₁-C₁₀-alkylene or C₆-C₁₂-arylene.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of those compounds in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers containing allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Instead of graft polymers whose structure has more than one shell, it is also possible to use homogeneous, i.e. single-shell, elastomers made from 1,3-butadiene, isoprene, and n-butyl acrylate, or copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate/glycidyl acrylate or n-butyl acrylate/glycidyl methacrylate copolymers, graft polymers having an inner core composed of n-butyl acrylate or based on butadiene and an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603, EP-A 319 290.

Of course, it is also possible to use mixtures of the types of rubber listed above.

Fibrous or particulate fillers (component E)) which may be mentioned are carbon fibers, glass fibers, glass beads, amorphous silica, asbestos, calcium silicate, calcium metasilicate, magnesium carbonate, kaolin, chalk, powdered quartz, mica, barium sulfate, and feldspar, used in amounts of up to 50% by weight, in particular from 1 to 50% by weight, preferably from 5 to 40% by weight, and in particular from 15 to 35% by weight.

Preferred fibrous fillers which may be mentioned are carbon fibers, aramid fibers, and potassium titanate fibers, particular preference being given to glass fibers in the form of E glass. These may be used as rovings or as the commercially available forms of chopped glass.

The fibrous fillers may have been surface-pretreated with a silane compound to improve compatibility with the thermoplastic.

Suitable silane compounds have the formula 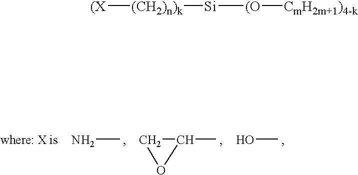
n is an integer from 2 to 10, preferably 3 to 4
m is an integer from 1 to 5, preferably 1 to 2, and
k is an integer from 1 to 3, preferably 1.

Preferred silane compounds are aminopropyltrimethoxysilane, aminobutyltrimethoxysilane, aminopropyltriethoxysilane, and aminobutyltriethoxysilane, and also the corresponding silanes which contain a glycidyl group as substituent X.

The amounts generally used of the silane compounds for surface coating are from 0.05 to 5% by weight, preferably from 0.5 to 1.5% by weight, and in particular from 0.8 to 1% by weight (based on C)).

Acicular mineral fillers are also suitable.

For the purposes of the present invention, acicular mineral fillers are mineral fillers with strongly developed acicular character. An example is acicular wollastonite. The mineral preferably has an L/D (length to diameter) ratio of from 8:1 to 35:1, with preference from 8:1 to 11:1. The mineral filler may, where appropriate, have been pretreated with the abovementioned silane compounds, but the pretreatment is not essential.

Other fillers which may be mentioned are kaolin, calcined kaolin, wollastonite, talc, and chalk.

Other colorants which may be added are inorganic pigments, such as ultramarine blue, iron oxide, titanium dioxide, zinc sulfide, and carbon black, and organic pigments, such as phthalocyanines, quinacridones, and perylenes, and also dyes, such as nigrosin and anthraquinones. Any desired flame retardants may also be added. These compounds are familiar to the skilled worker.

Plasticizers which may be mentioned by way of example are dioctyl phthalate, dibenzyl phthalate, butyl benzyl phthalate, hydrocarbon oils, and N-(n-butyl)benzenesulfonamide.

The thermoplastic molding compositions of the invention may be prepared by processes known per se, by using conventional mixing apparatus, such as screw extruders, Brabender mills, or Banbury mills, to mix the starting components, and then extruding these. The extrudate may be cooled and comminuted. It is also possible to premix individual components and then to add the remaining starting materials individually and/or likewise mixed. In one preferred embodiment, components A) and B) may in particular be mixed in advance in the form of pellets.

One particularly preferred preparation process additionally reduces tendency toward fogging and comprises mixing components A) to C), and also, where appropriate, D) and/or E), compounding them in the presence of water, and devolatilizing, discharging, cooling, and pelletizing the product. The amounts of water preferably added are from 0.1 to 2, preferably from 0.1 to 1.5% by weight, based on 100% by weight of components A) and B).

It is particularly preferable for water to be added to the previously homogenized melt of the other components. The mixing temperatures are generally from 230 to 290° C.

In one preferred method of operation, components C) to E) may be mixed with a polyester prepolymer A) or B), compounded, and pelletized. The resultant pellets are then condensed in the solid phase under an inert gas, continuously or batchwise, at below the melting point of component A) and, respectively, B), until the desired viscosity has been achieved.

The thermoplastic molding compositions of the invention have good dimensional stability and high heat resistance, and a very low level of fogging. They are therefore particularly suitable for automotive applications, and headlamp panels may be mentioned as a particularly preferred application.

### EXAMPLES

Component A: Polybutylene terephthalate (PBT) with a viscosity number (VN) of 157 ml/g and a carboxy end group content of 33 mval/kg (VN measured in 0.5% strength by weight solution of phenol/o-dichlorbenzene, 1:1 mixture, at 25° C. to ISO 1628).

Component B: Polybutylene terephthalate (PBT) with a viscosity number (VN) of 130 ml/g and a carboxy end group content of 25 mval/kg (VN measured in 0.5% strength by weight solution of phenol/o-dichlorbenzene, 1:1 mixture, at 25° C. to ISO 1628).

Component C: Talc

Component D1: Glycerol distearate (Loxiol® VPG 1206 from Cognis GmbH)

Component D2: Triglyceride with fatty acids (Loxiol® EP 218 from Cognis GmbH) Compenent E1: Masterbatch composed of 20% by weight of carbon black (median particle size d₅₀<20 μm) and 80% by weight of PBT with VN of 130 ml/g

Component E2: Masterbatch composed of 40% by weight of carbon black and 60% by weight of polyethylene

Preparation of Molding Compositions

Components A) to E) were mixed, homogenized, pelletized, and dried in an extruder at 260° C., the quantitative proportions being those given in the table. Components A) and B) were premixed at RT in the form of pellets.

The following measurements were made:

Impact strength was measured to ISO 179/1 eU at 23° C. Modulus of elasticity was measured to ISO 527-2.

Heat resistance was determined to ISO 75A and ISO 75 B, and the Vicat softening point was determined to ISO 306.

Formation of deposit (fogging) was determined as follows:

The apparatus was composed of a metal box (l=100 mm; w=72 mm; h=120 mm) in whose base there was an H1 (24V, 60 W) bulb on both the left-hand and right-hand side. These had been connected to a 10 A power supply unit adjustable from 0 to 30V.

Over the lamps there was a metal plate of thickness 2 mm. A temperature sensor had been attached within the test space and was used to control the temperature in the interior. A glass plate of thickness about 4 mm covered the metal box.

The pellets (10 g) or specimen plaque (30×60×2 mm, produced at a melt temperature of 260° C. and a mold temperature of 60° C.) were heated to 200° C. in the apparatus and held at 200° C. for 1 hour. The glass cover of the apparatus was weighed at the start of the experiment and at the end, after cooling. The difference between the weights corresponded to the fogging deposit.

The compositions of the molding compositions and the results of the measurements are found in Table 1.

TABLE 1

| Composition | | | | | | | |
|---|---|---|---|---|---|---|---|
| in % by weight | 1c | 2c | 3 | 3c | 4 | 5 | 4c |
| Component A | 50 | 70 | 50 | 50 | 69.5 | 49.1 | 99.65 |
| Component B | 49.7 | 29.8 | 49.6 | 49.8 | 30 | 49.2 | — |
| Component C | — | — | 0.2 | — | — | — | — |
| Component D1 | — | 0.2 | 0.2 | 0.2 | 0.2 | 0.2 | 0.35 |
| Component D2 | 0.3 | — | — | — | — | — | — |
| Component E1 | — | — | — | — | | 1.5 | — |
| Component E2 | — | — | — | — | 0.75 | — | — |
| ISO 75 A [° C.] | 52.2 | 51.4 | 57.4 | 51.9 | 52.5 | 51.9 | 52.3 |
| ISO 75 B [° C.] | 126.9 | 117.9 | 157.8 | 118.4 | 140 | 139.9 | 130.8 |
| Vicat B [° C.] | 173.4 | 172.6 | 186.6 | 169.1 | 180.6 | 177.2 | 171.2 |
| Deposit formed [ppm] | 65 | 100 | 58 | 64 | 50 | 20 | 400 |

c = for comparison

Preparation of Molding Compositions with Water

Components A) to E) are compounded as described above, the quantitative proportions as given Table 2. Example I was carried out without adding water, and Examples II, III, IV were carried out using 0.5%, 1%, and 1.5% of water (based on the total amount used, 100% by weight of components A) and B)). A pump was used to add the material into the melt of components A) to E).

The extent of deposit was determined for the pellets 1. visually and 2. by the following method:

The apparatus was composed of a metal box (1=100 mm; w=72 mm; h=120 mm) in whose base there was an H1 (24V, 60 W) bulb on both the left-hand and right-hand side. These had been connected to a 10 A power supply unit adjustable from 0 to 30V.

Over the lamps there was a metal plate of thickness 2 mm. A temperature sensor had been attached within the test space and was used to control the temperature in the interior. A glass plate of thickness about 4 mm covered the metal box.

The pellets (10 g) or specimen plaque (30×60×2 mm, produced at a melt temperature of 260° C. and a mold temperature of 60° C.) were heated to 200° C. in the apparatus and held at 200° C. for 1 hour. The glass cover of the apparatus was weighed at the start of the experiment and at the end, after cooling. The difference between the weights corresponded to the fogging deposit.

The compositions of the molding compositions and the results of the measurements are found in Table 2.

TABLE 2

| Composition in [% by | | | | |
|---|---|---|---|---|
| weight] | I | II | III | IV |
| Component A | 49.6 | 49.6 | 49.6 | 49.6 |
| Component B | 50 | 50 | 50 | 50 |
| Component C | 0.1 | 0.1 | 0.1 | 0.1 |
| Component D | 0.3 | 0.3 | 0.3 | 0.3 |
| Extent of deposit [mg] | 17 | 13 | 10 | 12 |
| Visual | marked deposit | moderate | little | moderate |
| Water feed % H₂O | 0 | 0.5 | 1.0 | 1.5 |
| (based on 100% by | | | | |
| weight of components | | | | |
| A + B) | | | | |

c= for comparison

1. A process for preparing thermoplastic molding compositions, wherein the thermoplastic molding compositions comprise:
A) from 10 to 89.9% by weight of a thermoplastic polyester with a viscosity number (VN) of at least 145 ml/g;
B) from 10 to 89.99% by weight of a thermoplastic polyester with a viscosity number (VN) of not more than 135 ml/g;
C) from 0.01 to 5% by weight of at least one nucleating agent;
D) from 0 to 5% by weight of at least one lubricant; and
E) from 0 to 70% by weight of other additives, the total of the percentages by weight of components A) to E) being 100%
and the process comprises mixing components A) to C), and also, where appropriate, at least one of D) and E), compounding them in the presence of water, and devolatilizing, discharging, cooling, and pelletizing the product.

2. The process according to claim 1, wherein use is made of from 0.1 to 2% by weight of water, based on 100% by weight of components A) and B).

3. The A process according to claim 1, wherein component B) has a VN of at least 90 ml/g.

4. The process according to claim 1, wherein component C) is composed of talc.

5. The process according to claim 1, wherein component A) has a carboxy end group value of more than 15 mval/kg.

6. The process according to claim 1, wherein component B) has a COOH end group value smaller than 30 mval/kg.

7. A method of using the molding compositions obtainable in accordance with the process conditions of claim 1 for producing moldings, films, or fibers.

8. A molding of any type obtainable in accordance with the process conditions of claim 1.

9. The molding according to claim 8, wherein the molding is a headlamp panel.

10. The process according to claim 2, wherein component B) has a VN of at least 90 ml/g.

11. The process according to claim 2, wherein component C) is composed of talc.

12. The process according to claim 3, wherein component C) is composed of talc.

13. The process according to claim 2, wherein component A) has a carboxy end group value of more than 15 mval/kg.

14. The process according to claim 3, wherein component A) has a carboxy end group value of more than 15 mval/kg.

15. The process according to claim 4, wherein component A) has a carboxy end group value of more than 15 mval/kg.

16. The process according to claim 2, wherein component B) has a COOH end group value smaller than 30 mval/kg.

17. The process according to claim 3, wherein component B) has a COOH end group value smaller than 30 mval/kg.

18. The process according to claim 4, wherein component B) has a COOH end group value smaller than 30 mval/kg.

19. The process according to claim 5, wherein component B) has a COOH end group value smaller than 30 mval/kg.
